(19) United States
(12) Patent Application Publication
(10) Pub. No.: US 2012/0287091 A1
(43) Pub. Date: Nov. 15, 2012

(54) ELECTRONIC PAPER LABEL APPARATUS

(75) Inventors: Wei-Chun HUANG, Taipei City (TW); Tsung-Hsing Hsieh, Taipei City (TW)

(73) Assignee: PRODIGID LIMITED

(21) Appl. No.: 13/103,180

(22) Filed: May 9, 2011

(51) Int. Cl. G09G 5/00

(52) U.S. Cl. 345/204

(57) ABSTRACT

An electronic paper label apparatus (10) includes a dual interface memory unit (102), a microcontroller unit (104) electrically connected to the dual interface memory unit (102), an electronic paper driver unit (106) electrically connected to the microcontroller unit (104), and an electronic paper unit (108) electrically connected to the electronic paper driver unit (106). The dual interface memory unit (102) includes a communication bus interface subunit (110) electrically connected to the microcontroller unit (104), a memory subunit (112) electrically connected to the communication bus interface subunit (110), a radio frequency interface subunit (114) electrically connected to the memory subunit (112), and a voltage regulator subunit (116) electrically connected to the radio frequency interface subunit (114), the microcontroller unit (104), and the electronic paper driver unit (106). The efficiency of the present invention is that the electronic paper label does not need the power of the batteries. The electronic paper label acquires power from the radio frequency identification signals, or from the near field communication signals.

### BACKGROUND OF THE INVENTION

1. Field of the Invention

The present invention relates to a label apparatus and in particular to an electronic paper label apparatus.

2. Description of Prior Art

The electronic paper is a great invention. Unlike the conventional display devices, the electronic paper is very light and thin, and is able to bend (namely, flexible). Changing the contents of the electronic paper will need power, but when there is no power for the electronic paper, the electronic paper still can display the original contents for several months. The electronic papers are used widely, for example the electronic shelf label system. The electronic shelf label system can save a lot of papers and labor cost.

But currently the electronic paper label of the electronic shelf label system needs the power of the batteries to change the contents (for example, the description of the goods, or price of the goods). So, when the batteries of the electronic paper label of the electronic shelf label system are out of power, the batteries of the electronic paper label of the electronic shelf label system will need to change. It is very inconvenient and not eco-friendly (because the junk batteries will cause environmental pollution).

### SUMMARY OF THE INVENTION

In order to solve the above-mentioned problems, an object of the present invention is to provide an electronic paper label apparatus, which does not need the power of the batteries.

In order to achieve the object of the present invention mentioned above, the electronic paper label apparatus of the present invention includes a dual interface memory unit, a microcontroller unit electrically connected to the dual interface memory unit, an electronic paper driver unit electrically connected to the microcontroller unit, and an electronic paper unit electrically connected to the electronic paper driver unit. The dual interface memory unit includes a communication bus interface subunit electrically connected to the microcontroller unit, a memory subunit electrically connected to the communication bus interface subunit, a radio frequency interface subunit electrically connected to the memory subunit, and a voltage regulator subunit electrically connected to the radio frequency interface subunit, the microcontroller unit, and the electronic paper driver unit.

The efficiency of the present invention is that the electronic paper label does not need the power of the batteries. The electronic paper label acquires power from the radio frequency identification signals, or from the near field communication signals.

### BRIEF DESCRIPTION OF DRAWING

FIG. 1 shows a block diagram of the electronic paper label apparatus of the present invention.

### DETAILED DESCRIPTION OF THE INVENTION

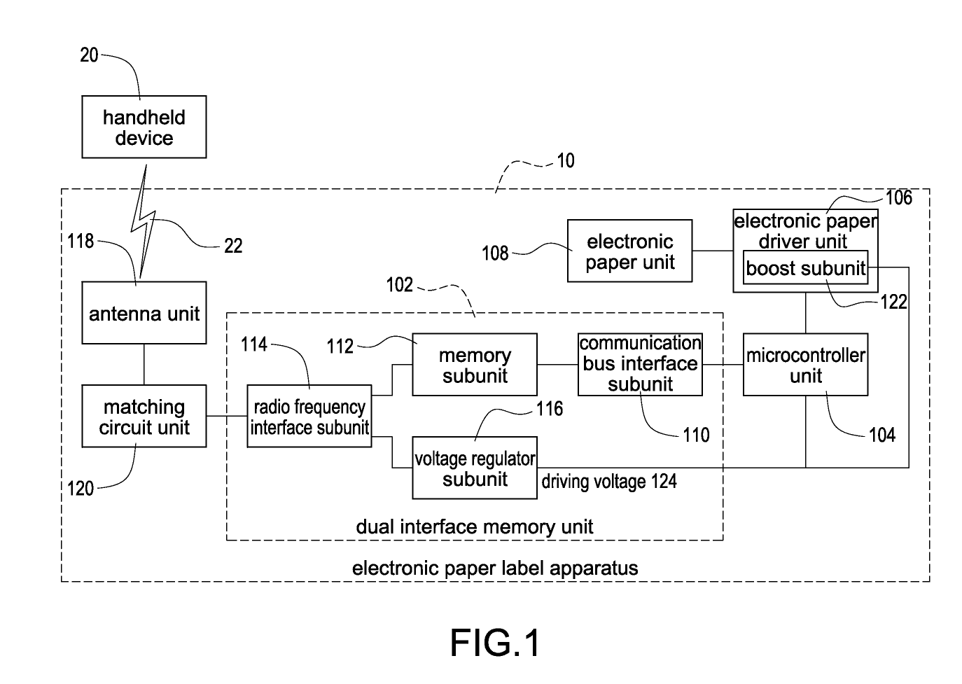

FIG. 1 shows a block diagram of the electronic paper label apparatus of the present invention. The electronic paper label apparatus 10 of the present invention is applied to a handheld device 20. The electronic paper label apparatus 10 includes a dual interface memory unit 102, a microcontroller unit 104, an electronic paper driver unit 106, an electronic paper unit 108, an antenna unit 118, and a matching circuit unit 120.

The dual interface memory unit 102 includes a communication bus interface subunit 110, a memory subunit 112, a radio frequency interface subunit 114, and a voltage regulator subunit 116. The electronic paper driver unit 106 includes a boost subunit 122.

The microcontroller unit 104 is electrically connected to the dual interface memory unit 102. The electronic paper driver unit 106 is electrically connected to the microcontroller unit 104. The electronic paper unit 108 is electrically connected to the electronic paper driver unit 106.

The communication bus interface subunit 110 is electrically connected to the microcontroller unit 104. The memory subunit 112 is electrically connected to the communication bus interface subunit 110. The radio frequency interface subunit 114 is electrically connected to the memory subunit 112. The voltage regulator subunit 116 is electrically connected to the radio frequency interface subunit 114, the microcontroller unit 104, and the electronic paper driver unit 106.

The antenna unit 118 is electrically connected to the radio frequency interface subunit 114. The matching circuit unit 120 is electrically connected to the radio frequency interface subunit 114, and the antenna unit 118. The boost subunit 122 is electrically connected to the voltage regulator subunit 116.

The handheld device 20 could be a personal digital assistant (PDA), or a smart mobile phone. A wireless signal 22 is sent from the handheld device 20 to the antenna unit 118. The wireless signal 22 could be a radio frequency identification (RFID) signal, or a near field communication (NFC) signal. The radio frequency identification signal could be high frequency radio frequency identification, for example ISO15693, ISO14443A, ISO14443B, or could be low frequency radio frequency identification, for example ISO11784, ISO11785.

The wireless signal 22 is sent from the antenna unit 118 to the matching circuit unit 120 and the radio frequency interface subunit 114 after the wireless signal 22 is received by the antenna unit 118. The radio frequency interface subunit 114 could be a radio frequency identification interface, or a near field communication interface.

The wireless signal 22 is sent from the radio frequency interface subunit 114 to the memory subunit 112 after the wireless signal 22 is received by the radio frequency interface subunit 114. The wireless signal 22 is induced to be an induced current by the antenna unit 118. An induced voltage is sent from the radio frequency interface subunit 114 to the voltage regulator subunit 116 after the induced current is transformed to the induced voltage by the radio frequency interface subunit 114. The dual interface memory unit 102 could be a dual interface electrically erasable programmable read only memory (dual interface EEPROM). The memory subunit 112 could be an electrically erasable programmable read only memory (EEPROM).

The message information (for example, the description of the goods, or price of the goods) of the wireless signal 22 is stored in the memory subunit 112 after the wireless signal 22 is received by the memory subunit 112. The energy of the induced voltage is transformed to a driving voltage 124 (for example 2.6 to 3 voltages) by the voltage regulator subunit 116 after the induced voltage is received by the voltage regulator subunit 116. The driving voltage 124 is sent from the voltage regulator subunit 116 to the microcontroller unit 104 and the electronic paper driver unit 106 to drive the microcontroller unit 104 and the electronic paper driver unit 106.

In an embodiment, the energy of the wireless signal 22 might be small (for example 2.6 voltages 7 mA), so the power consumption of the components of the electronic paper label apparatus 10 would be small as well.

The message information of the wireless signal 22 stored in the memory subunit 112 is read by the microcontroller unit 104 through the communication bus interface subunit 110 after the microcontroller unit 104 is driven. The message information of the wireless signal 22 is sent from the microcontroller unit 104 to the electronic paper driver unit 106 after the message information of the wireless signal 22 stored in the memory subunit 112 is read by the microcontroller unit 104.

The communication bus interface subunit 110 could be an inter integrated circuit (I²C) bus. The electronic paper driver unit 106 is controlled by the microcontroller unit 104 through the serial peripheral interface (SPI).

The driving voltage 124 is transformed to 38 voltages by the boost subunit 122 to drive the electronic paper unit 108 after the electronic paper driver unit 106 is driven. The electronic paper unit 108 is controlled by the electronic paper driver unit 106 to display the message information of the wireless signal 22 after the message information of the wireless signal 22 is received by the electronic paper driver unit 106.

The radio frequency identification signal or the near field communication signal is transformed to the driving voltage 124 to drive the components of the electronic paper label apparatus 10 (for example, the microcontroller unit 104 and the electronic paper driver unit 106) after the radio frequency identification signal or the near field communication signal sent from the handheld device 20 is received by the electronic paper label apparatus 10. Therefore, unlike the prior arts, the electronic paper label apparatus 10 of the present invention does not need the power of the batteries.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electronic paper label apparatus (10) including:
a dual interface memory unit (102);
a microcontroller unit (104) electrically connected to the dual interface memory unit (102);
an electronic paper driver unit (106) electrically connected to the microcontroller unit (104); and
an electronic paper unit (108) electrically connected to the electronic paper driver unit (106),
wherein the dual interface memory unit (102) includes:
a communication bus interface subunit (110) electrically connected to the microcontroller unit (104);
a memory subunit (112) electrically connected to the communication bus interface subunit (110);
a radio frequency interface subunit (114) electrically connected to the memory subunit (112); and
a voltage regulator subunit (116) electrically connected to the radio frequency interface subunit (114), the microcontroller unit (104), and the electronic paper driver unit (106).

2. The electronic paper label apparatus (10) in claim 1, wherein the dual interface memory unit (102) is a dual interface electrically erasable programmable read only memory.

3. The electronic paper label apparatus (10) in claim 2, wherein the memory subunit (112) is an electrically erasable programmable read only memory.

4. The electronic paper label apparatus (10) in claim 3, further including an antenna unit (118) electrically connected to the radio frequency interface subunit (114).

5. The electronic paper label apparatus (10) in claim 4, wherein the radio frequency interface subunit (114) is a radio frequency identification interface.

6. The electronic paper label apparatus (10) in claim 4, wherein the radio frequency interface subunit (114) is a near field communication interface.

7. The electronic paper label apparatus (10) in claim 4, further including a matching circuit unit (120) electrically connected to the radio frequency interface subunit (114) and the antenna unit (118).

8. The electronic paper label apparatus (10) in claim 7, wherein the electronic paper driver unit (106) includes a boost subunit (122) electrically connected to the voltage regulator subunit (116).

9. The electronic paper label apparatus (10) in claim 8, wherein the communication bus interface subunit (110) is an inter integrated circuit bus.

10. The electronic paper label apparatus (10) in claim 9, wherein the electronic paper driver unit (106) is controlled by the microcontroller unit (104) through the serial peripheral interface.
